(19) United States
(12) Patent Application Publication
(10) Pub. No.: US 2015/0050931 A1
(43) Pub. Date: Feb. 19, 2015

(54) DETERMINING AN IDENTIFICATION OF A CELL

(71) Applicants: Lauri Aarne Johannes Wirola, Tampere (FI); Tommi Antero Laine, Tampere (FI); Jari Syrjarinne, Tampere (FI)

(72) Inventors: Lauri Aarne Johannes Wirola, Tampere (FI); Tommi Antero Laine, Tampere (FI); Jari Syrjarinne, Tampere (FI)

(21) Appl. No.: 14/383,536

(22) PCT Filed: Mar. 15, 2012
(86) PCT No.: PCT/IB2012/051228

§ 371 Date: Sep. 5, 2014

(51) Int. Cl. H04W 48/16; H04W 64/00; H04W 24/10

(52) U.S. Cl. CPC H04W 48/16; H04W 24/10; H04W 64/003
USPC 455/434

(57) ABSTRACT

An apparatus receives a plurality of reports from at least one mobile terminal, which is connected to a particular cell of a cellular communication network. Each report includes an identification of a first type of a plurality of cells of the cellular communication network currently observed by the at least one mobile terminal and, associated with each identification of the first type, a result of at least one measurement on signals. The apparatus computes for each identification of the first type, a result of at least one measurement in the plurality of reports. The apparatus then determines, based on the computed sums, one of the identifications of the first type to be an identification of the first type of the particular cell.

### FIELD OF THE DISCLOSURE

The invention relates to the identification of cells in a cellular communication system, and more specifically to the determination of such identification.

### BACKGROUND

Cellular base stations of various cellular communication systems can be considered to have two identities. The first identity is a global cell identity (GCI), which uniquely distinguishes any given base station globally.

The other identity is a local cell identity (LCI), which is related to the physical resources allocated to a cell. The local cell identity may repeat in the network.

The identity of cells may be used for instance for positioning purposes. For example, modem global cellular and non-cellular positioning technologies are based on generating large global databases containing information on cellular and non-cellular signals. The information may originate entirely or partially from users of these positioning technologies.

The information provided by users is typically in the form of “fingerprints”, which contain a location that is estimated based on, e.g., received satellite signals of a global navigation satellite system (GNSS) and the measurements taken from one or more radio interfaces for signals of a cellular and/or non-cellular terrestrial system. In the case of measurements on cellular signals, the results of the measurements may contain a global and/or local identification of the cellular network cells observed, their signal strengths and/or pathlosses and/or timing measurements like timing advance (TA) or round-trip time. For measurements on wireless local area network (WLAN) signals, as an example of signals of a non-cellular system, the results of the measurements may contain a basic service set identification (BSSID), like the medium access control (MAC) address of observed access points, the service set identifier (SSID) of the access points, and the signal strength of received signals (received signal strength indication RSSI or physical Rx level in dBm with a reference value of 1 mW, etc.).

This data may then be transferred to a server or cloud, where various radio models may be generated for positioning purposes. In the end, these refined radio models may be transferred back to user terminals for use in position determination.

It is to be understood that the identification of cells of a cellular network could also be needed for other purposes than positioning purposes.

### SUMMARY OF SOME EMBODIMENTS OF THE INVENTION

A method is described, which comprises at an apparatus receiving a plurality of reports from at least one mobile terminal, which is connected to a particular cell of a cellular communication network, each report including an identification of a first type of a plurality of cells of the cellular communication network currently observed by the at least one mobile terminal and, associated with each identification of the first type, a result of at least one measurement on signals. The method further comprises computing for each identification of the first type a sum of results of the at least one measurement in the plurality of reports. The method further comprises determining, based on the computed sums, one of the identifications of the first type to be an identification of the first type of the particular cell.

Moreover a first apparatus is described, which comprises means for realizing the actions of the presented method.

The means of this apparatus can be implemented in hardware and/or software. They may comprise for instance a processor for executing computer program code for realizing the required functions, a memory storing the program code, or both. Alternatively, they could comprise for instance circuitry that is designed to realize the required functions, for instance implemented in a chipset or a chip, like an integrated circuit.

Moreover a second apparatus is described, which comprises at least one processor and at least one memory including computer program code, the at least one memory and the computer program code configured to, with the at least one processor, cause an apparatus at least to perform the actions of the presented method.

Moreover a non-transitory computer readable storage medium is described, in which computer program code is stored. The computer program code causes an apparatus to realize the actions of the presented method when executed by a processor.

The computer readable storage medium could be for example a disk or a memory or the like. The computer program code could be stored in the computer readable storage medium in the form of instructions encoding the computer-readable storage medium. The computer readable storage medium may be intended for taking part in the operation of a device, like an internal or external hard disk of a computer, or be intended for distribution of the program code, like an optical disc.

It is to be understood that also the computer program code by itself has to be considered an embodiment of the invention.

Any of the described apparatuses may comprise only the indicated components or one or more additional components.

Any of the described apparatuses may be a module or a component for a device, for example a chip. Alternatively, any of the described apparatuses may be a device, for instance a server or a mobile terminal.

In one embodiment, the described methods are information providing methods, and the described first apparatus is an information providing apparatus. In one embodiment, the means of the described first apparatus are processing means.

In certain embodiments of the described methods, the methods are methods for determining an identification of a cell. In certain embodiments of the described apparatuses, the apparatuses are apparatuses for determining an identification of a cell.

Further, it is to be understood that the presentation of the invention in this section is merely exemplary and non-limiting.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a schematic block diagram of an apparatus;

FIG. 2 is a flow chart illustrating a method;

FIG. 3 is a schematic block diagram of a system;

FIG. 4 is a diagram illustrating selected areas of a serving cell and neighboring cells; and

FIG. 5 is a flow chart illustrating an exemplary operation in the system of FIG. 3.

### DETAILED DESCRIPTION OF THE FIGURES

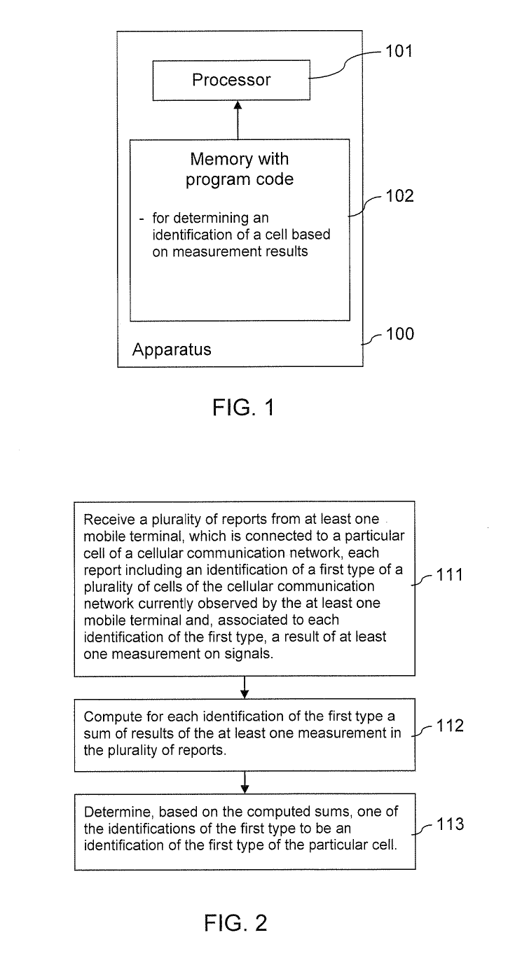

FIG. 1 is a schematic block diagram of a first apparatus 100. Apparatus 100 comprises a processor 101 and, linked to processor 101, a memory 102. Memory 102 stores computer program code for determining an identification of a particular cell. Processor 101 is configured to execute computer program code stored in memory 102 in order to cause an apparatus to perform desired actions.

Apparatus 100 could be a server or any other device, for instance a mobile terminal. Apparatus 100 could equally be a module for a server or for any other device, like an encoder, a codec, a chip, circuitry on a chip or a plug-in board. Apparatus 100 is an exemplary embodiment of any apparatus according to the invention. Optionally, apparatus 100 could have various other components, like a data interface, a user interface, a further memory, a further processor, etc.

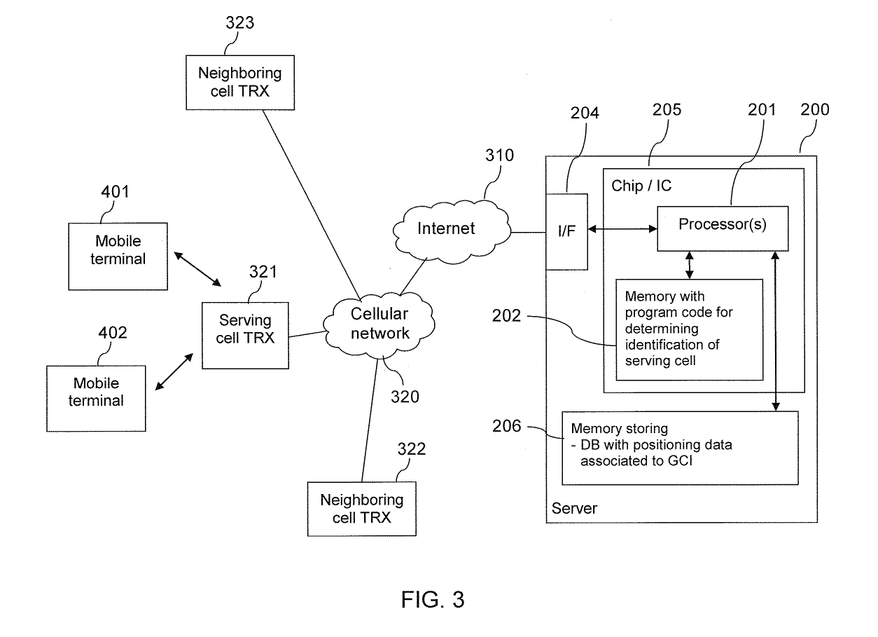

An operation of apparatus 100 will now be described with reference to the flow chart of FIG. 2. The operation is an exemplary embodiment of a method according to the invention. Processor 101 and the program code stored in memory 102 cause an apparatus to perform the operation when the program code is retrieved from memory 102 and executed by processor 101. The apparatus that is caused to perform the operation can be apparatus 100 or some other apparatus, in particular a device comprising apparatus 100.

The apparatus receives a plurality of reports from at least one mobile terminal, which is connected to a particular cell of a cellular communication network. Each report includes an identification of a first type of a plurality of cells of the cellular communication network currently observed by the at least one mobile terminal and, associated with each identification of the first type, a result of at least one measurement on signals. (action 111)

The apparatus furthermore computes for each identification of the first type a sum of results of the at least one measurement in the plurality of reports. (action 112)

The apparatus furthermore determines, based on the computed sums, one of the identifications of the first type to be an identification of the first type of the particular cell. (action 113)

Certain embodiments of the invention may thus enable an apparatus to derive an identification of a particular cell based on measurement results that are provided by mobile terminals along with an associated identification of a plurality of observed cells. Certain embodiments of the invention may enable an apparatus in particular to derive such identification by determining and evaluating sums of measurement results for each of the plurality of observed cells.

It is to be understood that the computed sums could also be an intermediate product, for instance for average values or moving average values that are eventually evaluated for determining the identification of the first type of the particular cell.

Certain embodiments of the invention may thus have the effect that an identification of a certain type of a particular cell may be learned in a straightforward manner, even if an explicit association of an identification of this type to the particular cell is not provided in the reports of the mobile terminals. Such identification may be a local cell identity (LCI) or an identity of any other type for which no explicit association to a particular cell is provided.

Apparatus 100 illustrated in FIG. 1 and the operation illustrated in FIG. 2 may be implemented and refined in various ways.

The cellular communication network could be a GERAN (global system for mobile telecommunications/enhanced data rates for global evolution radio access network GSM/EDGE RAN), but equally any other type of cellular communication network, like an UTRAN (universal mobile telecommunication system radio access network, UMTS RAN), an E-UTRAN (evolved UTRAN) or a CDMA (code division multiple access) network.

The mobile terminals providing the reports could comprise for example communication terminals, like mobile phones, smart phones, laptops, tablet computers, etc. It is to be understood that a mobile terminal providing a report could also be any other kind of mobile device that is able to receive and evaluate signals from a cellular communication network, even if this device is not configured to communicate with or via the network. Such a mobile terminal could for instance be considered to be “connected” to a particular cell of a cellular communication network, if this is the cell from which the mobile terminal currently receives signals with the highest power.

The reports could be reports for internal use in a mobile terminal, or reports that are transmitted by a mobile terminal in a message to some other apparatus, for instance to a server.

In an exemplary embodiment, each report further includes an identification of a second type for the particular cell.

The identification of the first type could be for instance a local cell identity and the identification of the second type could be for instance a global cell identity. While a mapping between local cell identity and global cell identity may be easy for an operator of a cellular communication network, because the operator knows for each global cell identity the associated local cell identity, this information may not be available to other service providers or to users.

The global cell identity (ID) may be a distinguished name (DN) of the cell. To exemplify, in GSM networks the cell is identified globally by a DN chain with the following components:

Mobile Country Code (0-999)

Mobile Network Code (0-999)

Location Area Code (0-65535)

Cell ID (0-65535)

These four parameters distinguish any given GSM base station uniquely globally. As a further example, in UTRA networks the base station is identified by a DN chain with the following components:

Mobile Country Code (0-999)

Mobile Network Code (0-999)

UTRA Cell ID (0-268435455)

Again, these three parameters distinguish any given UTRAN base station uniquely globally. In both cases, the numbers in parentheses behind each parameter indicate the range of values that may be associated with each parameter.

The local cell identity may be related to the physical resources allocated to the cell. For example, in the case of GERAN the physical resources are the cell tower with a certain base station identity code (BISC) and the frequency in the form of the absolute radio frequency channel (ARFCN), which is also known as broadcast control channel (BCCH). The physical resources are re-used in the network; that is, the same BSIC/ARFCN combination repeats in the network.

Thus, when receiving a global cell identity of a particular cell and determining the local cell identity of the particular cell based on the equally received measurement results, it is possible to map this local cell identity and the associated measurement results to the global cell identity of the particular cell.

In an exemplary embodiment of the invention, the particular cell could be a serving cell, but it is to be understood that it could be any other kind of observed cell as well.

In an exemplary embodiment of the invention, the at least one measurement on signals is a signal strength measurement. A result of such a measurement could be an Rx level, which indicates the power of a received signal in dBm.

The signal strength measurement results could be received from a mobile terminal for instance in a message comprising a cellular measurement report. The following Table 1 shows the structure of a standard cellular measurement report in a GERAN network. The header part carries the distinguished name of the serving cell and is followed by the network measurement report (NMR). The network measurement report includes for all cells that are observed by the mobile terminal the components of the local cell identity and an associated Rx level as the result of a signal strength measurement on signals transmitted by the identified cell.

TABLE 1

Serving cell
Mobile Country Code
Mobile Network Code
Location Area Code
Cell Identity
Network measurement
(repeats for all cells observed)
Base Station Identity Code
Absolute Radio Frequency Channel
Rx level

This cellular measurement report does not include any indication, which one of the contained measurements belongs to the identified serving cell. Thus, the Rx level of the serving cell cannot be determined without learning at first the local cell identity of the serving cell. Only with this knowledge, full advantage of the measurements in a cellular measurement report can be taken.

A comprehensive database which stores information on cells may preferably be based on global cell identities, in order to have a unique identifier for the cells. If cellular measurement reports are to be used as a source of data on a serving cell, one of the included local cell identities must be mapped to the included global cell identity of the serving cell, before the data can be correctly stored in such a database.

It is to be understood that the report presented in Table 1 is only provided as an example. In an alternative embodiment, the report could also be defined for example such that the information in the header part does not necessarily relate to the serving cell. Instead, it could relate to some other cell for which the mobile terminal has determined and included a global cell identity. Furthermore, report provided by a mobile terminal could be defined such that it comprises only a network measurement report and no header part. In this network measurement report, the record for one cell could comprise a global cell identity, while the record for all other cells could comprise only a local cell identity.

In an exemplary embodiment of the invention, determining one of the identifications of the first type to be an identification of the first type of the particular cell comprises determining the identification of the first type which is associated with the computed highest sum to be the identification of the first type of the particular cell.

Such an approach may be used for instance, if the received report includes measurement results that can be expected to be higher, on average, for the particular cell than for other observed cells, as in the case of signal strengths. In case other types of measurement results are included in the report and to be evaluated, which can be expected to be lower, on average, for the particular cell than for other observed cells, the identification of the first type which is associated with the lowest computed sum could be determined to be the identification of the first type of the particular cell. Such other types of measurement results could comprise for instance the pathloss of signals.

In an exemplary embodiment of the invention, the sums are computed cumulatively at least until one of the computed sums exceeds a threshold value, before determining one of the identifications of the first type to be the identification of the first type of the particular cell based on the computed sums. This may have the effect that the identification of the first type of the particular cell can be determined with a high reliability, since it may be ensured that the sample set is sufficiently large. The threshold value may be set to any suitable value.

In an exemplary embodiment of the invention, the sums are computed cumulatively at least until a ratio between a highest computed sum and a second highest computed sum exceeds a threshold value, before determining one of the identifications of the first type to be the identification of the first type of the particular cell based on the computed sums. This may have the effect that the identification of the first type of the particular cell can be determined with a sufficient confidence.

In both cases, the threshold value may be set to any suitable value that can be expected to result in a desired reliability while avoiding at the same time the requirement to receive an extensive number of reports before the identification can be determined

In an exemplary embodiment of the invention, the sums are reset at certain times. They could be reset for instance periodically and/or after one of the computed sums has reached a threshold value. This may have the effect that the identification can be re-learned effectively to take account of errors in a determination or to take account of a reallocation of identifications. In case the identification is the same as before, the process should lead to the same result as before. Alternatively, in case the identification has changed, the process leads to learning the new identification.

In an exemplary embodiment of the invention, at least one of the reports comprises in addition an indication of a position of the mobile terminal providing the report. This may have the effect that the provided measurement results and/or the particular cell can be associated with a particular location.

In an exemplary embodiment of the invention, the sums are only updated based on the measurement results in a newly received report, in case a position indicated in the report or in a more comprehensive message fits to an earlier assumption on the location of the particular cell. For example, if a serving cell that is identified by an identification of a second type has previously been determined to be located in Tampere, but now a report is provided by a mobile terminal for a serving cell with the same identification of the second type and with a position in Helsinki, it is clear that there is either something wrong with the report or that the cell has moved. Therefore, available location information that is associated to a report can be used for an outlier detection method, such that the sums are only updated based on a new report, in case the validity of the report seems plausible based on the indicated position.

In an exemplary embodiment of the invention, results of measurements associated in the received reports to the identification of the first type, which is determined to be the identification of the first type of the particular cell, are stored in a positioning database with association to the identification of the second type for the particular cell. This may have the effect that the received data can be used for supporting a terrestrial radio signal based positioning of mobile terminals.

The terrestrial radio signals can be signals of a cellular system, for instance a global system for mobile communications (GSM), a 3rd Generation Partnership Project (3GPP) based cellular system like a wide-band code division multiple access (WCDMA) system or a time division synchronous CDMA (TD-SCDMA) system, a 3GPP2 system like a CDMA2000 system, a long term evolution (LTE) or LTE-Advanced system, or any other type of cellular system, like a worldwide interoperability for microwave access (WiMAX) system. Alternatively or in addition, the terrestrial radio signals can be signals of a non-cellular system, like WLAN, Bluetooth and Zigbee, etc.

FIG. 3 is a schematic block diagram of a system comprising an exemplary embodiment of an apparatus according to the invention, which is configured to learn an identification of a cell of a cellular communication network.

The system comprises a server 200. Server 200 is connected to a network 310, for example the Internet. Server 200 could also belong to network 310. Network 310 is suited to interconnect server 200 with mobile terminals 401, 402 via a cellular network 320. Mobile terminals 401, 402 currently access the cellular network 320 via the same serving cell transceiver 321. Mobile terminals 401, 402 are configured to observe in addition signals from neighboring cell transceivers 322, 323 of cellular network 320.

Server 200 may be for instance a dedicated positioning server, a position data learning server, or some other kind of server. It comprises a processor 201 that is linked to a first memory 202, to a second memory 206 and to an interface (I/F) 204. Processor 201 is configured to execute computer program code, including computer program code stored in memory 202, in order to cause server 200 to perform desired actions.

Memory 202 stores computer program code for determining a local cell identity of a serving cell of a cellular communication network. The computer program code may comprise for example similar program code as memory 102. The program code could belong for instance to a comprehensive application supporting a learning of position data and/or supporting a positioning of mobile terminals. In addition, memory 202 may store computer program code implemented to realize other functions, as well as any kind of other data. It is to be understood, though, that program code for any other actions than determining the identification of a serving cell could also be implemented on one or more other physical and/or virtual servers.

Processor 201 and memory 202 may optionally belong to a chip or an integrated circuit 205, which may comprise in addition various other components, for instance a further processor or memory.

Memory 206 stores at least one database that can be accessed by processor 201. The database is configured to store measurement data for the cells of the cellular communication network 320 on a per cell basis. In addition, memory 206 could store other data, for instance other data supporting a positioning of mobile terminals. It is to be understood that the memory storing the database could also be external to server 200; it could be for instance on another physical or virtual server.

Interface 204 is a component which enables server 200 to communicate with other devices, like mobile terminals 401 and 402, via network 310. Interface 204 could comprise for instance a TCP/IP socket.

Component 205 or server 200 could correspond to exemplary embodiments of an apparatus according to the invention.

Each transceiver 321, 322, 323 of cellular network 320 serves another cell. The cells are partly overlapping so that at least at some places, a mobile terminal receives signals from a plurality of cells, which are referred to as observed cells.

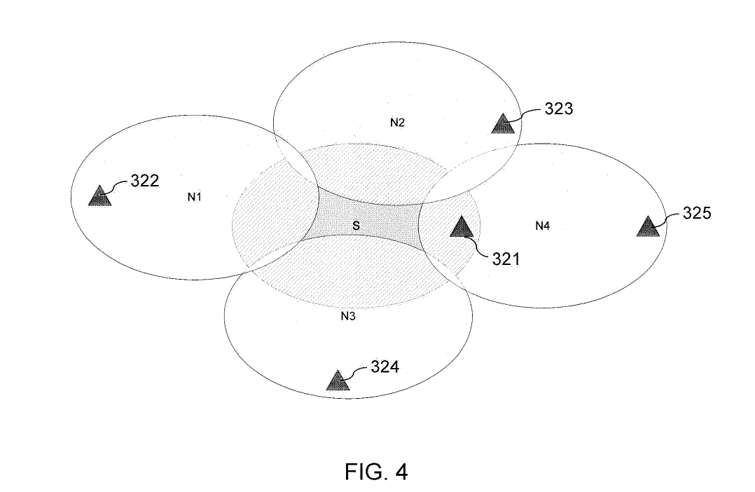

FIG. 4 illustrates the arrangement of cells by presenting selected areas of some cells.

In FIG. 4, transceiver 321 serves a particular cell. The region S in the center denotes the area in which this cell functions as a serving cell, while the cell is observable in a bigger area than region S. That is, as long as a mobile terminal is located in region S, the cell may be a serving cell for the mobile terminal. Regions N1 to N4 denote corresponding areas for cells that appear as neighbors to the serving cell and that are served by transceivers 322, 323, 324 and 325, respectively. Each of transceivers 321-325 may be or belong to a respective base station of cellular communication network 320.

A network measurement report that is assembled and provided by a mobile terminal will always contain measurement results for the current serving cell, since the serving cell is necessarily observable by this mobile terminal. Referring to FIG. 4, while a mobile terminal is located in region S, the associated serving cell is observable and thus appears in the network measurement report.

For a given serving cell, the record in the network measurement report part which corresponds to the serving cell typically indicates the highest signal strength. The reason is that when the Rx level of the serving cell drops below the Rx level of any other observable cell, there will be a cell re-selection/handover to this other cell soon. There is some hysteresis in the re-selection/handover behavior, though. When considering the geometry presented in FIG. 4, it can be seen that practically at all the locations in region S transceiver 321 is the closest transceiver and, thus, on average, the one providing the strongest signals.

When considering a sufficient number of network measurement reports that are received from locations distributed all over region S in which a given cell is a serving cell, it is possible to deduce which local cell identifier is associated on average to the strongest Rx level in the area. This local cell identifier can then be considered as the local cell identifier of the serving cell.

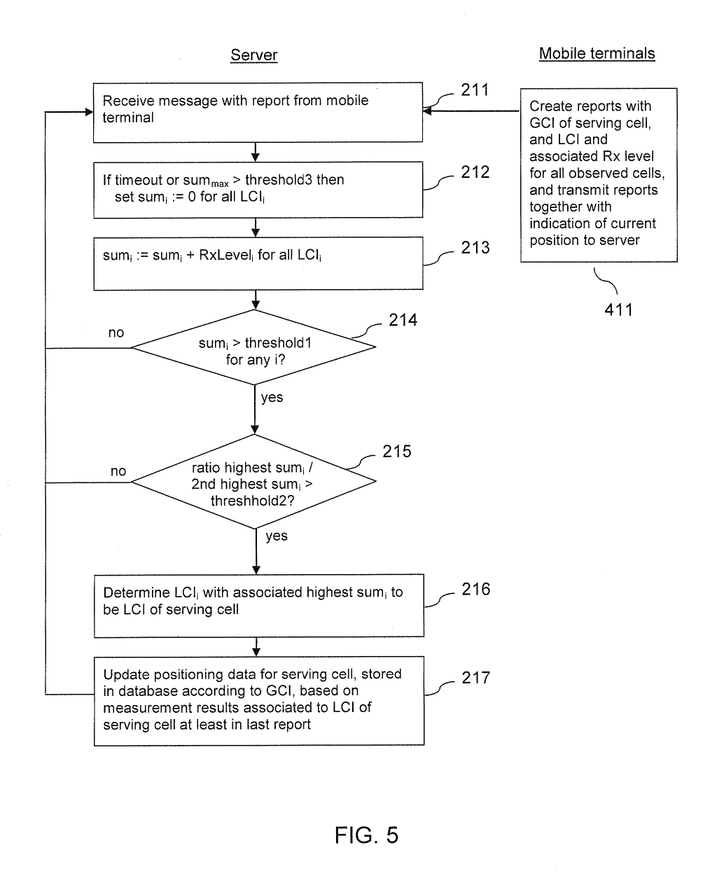

An exemplary operation in the system of FIG. 3 will now be described with reference to the flow chart of FIG. 5.

Operations at server 200 are presented on the left hand side of FIG. 5. Processor 201 and the program code stored in memory 202 cause server 200 to perform the presented operations when the program code is retrieved from memory 202 and executed by processor 201. Operations at mobile terminals 401, 402 are presented at the top on the right hand side of FIG. 5.

Mobile terminal 401 determines its current position e.g. based on satellite signals via a received GNSS receiver. In addition, mobile terminal 401 detects signals from all observable cells, for instance signals transmitted by transceivers 321, 322, 323 of cellular communication network 320, and performs measurements on the signal strength. The received signals include the local cell identity of the respective cell, which is composed of a base station identity and a frequency indication. Mobile terminal 401 generates a cellular measurement report using for example the structure presented in Table 1 above. That is, mobile terminal 401 generates a header with information on the global cell identity of the current serving cell and with a network measurement report. The information on the global cell identity could comprise for example a complete distinguished name chain. Alternatively, the information on the global cell identity might comprise for instance only some of the components of the distinguished name chain, for example the location area code (LAC) and the cell identity (CID) of the serving cell. The mobile country code (MCC) and the mobile network code (MNC) of the serving cell might be available from some other context in the report that is sent by mobile terminal 401 to server 200. The network measurement report includes for each observed cell a local cell identity of the observed cell and the measurement result for the observed cell. Mobile terminal 401 then transmits the assembled cellular measurement report to server 200. The report may be embedded to this end into a message, which includes in addition the determined position of mobile terminal 401. (action 411) The transmission may take place via cellular network 320 and network 310.

It is to be understood that other measurement results could be provided alternatively or in addition, like an indication of a timing advance, of a round-trip-time, etc. It has to be noted that mobile terminal 401 could assemble in addition measurements on signals transmitted by WLAN access points or other fixed station transceivers. It has further to be noted that in an alternative embodiment, the position of mobile terminal 401 could also be determined based on some other positioning technology than GNSS. For instance, if a mobile terminal only collects measurements on cellular radio signals for transmission to server 200, the mobile terminal could determine its position based on WLAN signals instead of GNSS signals.

Mobile terminal 401 may transmit such reports for the same serving cell from various locations while moving around. In addition, other mobile terminals that are attached to the same serving cell transceiver 321, for instance mobile terminal 402, may transmit corresponding reports to server 200.

Server 200 provides a learning system for building up and updating a positioning data learning database, for instance a fingerprint database. The database comprises data for each serving cell for which measurements have been provided so far. The data for a respective cell is stored with reference to a global cell identity for each cell. Server 200 receives cellular measurement reports from various mobile terminals 401, 402. (action 211)

Examples of the measurement results from five network measurement reports NMR 1 to NMR 5 of a respective incoming cellular measurement report, each associated with the same serving cell, are summarized in Table 2 below:

TABLE 2

| NMR 1 | NMR 2 | NMR 3 | NMR 4 | NMR 5 |
|---|---|---|---|---|
| LCI₁ | LCI₁ | LCI₁ | LCI₁ | LCI₁ |
| RxLevel₁ = | RxLevel₁ = | RxLevel₁ = | RxLevel₁ = | RxLevel₁ = |
| 32 | 49 | 58 | 35 | 85 |
| LCI₂ | LCI₂ | LCI₂ | LCI₂ | LCI₂ |
| RxLevel₂ = | RxLevel₂ = | RxLevel₂ = | RxLevel₂ = | RxLevel₂ = |
| 90 | 47 | 38 | 75 | 74 |
| LCI₃ | LCI₃ | LCI₃ | LCI₃ | LCI₃ |
| RxLevel₃ = | RxLevel₃ = | RxLevel₃ = | RxLevel₃ = | RxLevel₃ = |
| 58 | 18 | 12 | 46 | 52 |
| LCI₄ | LCI₅ | LCI₅ | LCI₄ | LCI₆ |
| RxLevel₄ = | RxLevel₅ = | RxLevel₅ = | RxLevel₄ = | RxLevel₆ = |
| 11 | 15 | 62 | 19 | 18 |
| | LCI₆ | | | |
| | RxLevel₆ = | | | |
| | 23 | | | |

There is an indication of an Rx level for four to five observed cells for local cell identities LCI₁, LCI₂, LCI₃, LCI₄, LCI₅ and/or LCI₆ in each report. For simplicity, it is assumed that the Rx level values are in the range [0,100] with 100 representing the highest signal strength.

Each cellular measurement report comprises in its header an indication of the global cell identity of the serving cell, but there is no link to one of the local cell identities. In order to be able to use the correct measurement results to update the data for the serving cell in the database, it is therefore necessary for server 200 to learn the local cell identity of the serving cell.

To this end, server 200 cumulatively sums the Rx level value RxLevel, for each local cell identity LCIᵢ from one measurement report to the next to obtain a sum, for each local cell identity LCIᵢ, with i=1 to 6. (action 213) A new record with a parameter sumₖ=0 is created for a respective LCIₖ, when data for a k^{th} local cell identity is received for the first time in a network measurement report for a respective serving cell.

The sums sumᵢ for each LCIᵢ might only be updated based on the Rx levels in the report, in case the position of the mobile terminal that is indicated in the message fits to an earlier assumption on the location of the serving cell.

After the processing of each incoming report for the same serving cell, server 200 determines whether the sum sumᵢ for any of local cell identity LCIᵢ exceeds a first predetermined threshold value threshold1. (action 214) For the example of Table 2, the first threshold value could be set for instance to “200”.

If the first threshold value is not exceeded, server 200 continues with adding the Rx level values from the next incoming network measurement report to the sums sum that have been determined so far for each LCIᵢ (actions 211, 213).

Otherwise, server 200 determines in addition whether the ratio between the current highest sum and the current second highest sum exceeds a second predetermined threshold value threshold2. (action 215) For the example of Table 2, the second threshold value could be set for instance to “1.2”.

If the second threshold value is not exceeded, server 200 continues with adding the Rx level values from the next incoming network measurement report to the sums sumᵢ that have been determined so far for each LCIᵢ (actions 211, 213).

If both the first threshold value and the second threshold value are exceeded, server 200 determines the local cell identity LCIᵢ with the associated highest sum sumᵢ to be the local cell identity of the serving cell. (action 216)

Table 3 below shows the development of the LCI learning information for the serving cell given the exemplary incoming Rx level values of Table 2.

TABLE 3

| LCI info | LCI info | LCI info | LCI info | LCI info |
|---|---|---|---|---|
| after NMR 1 | after NMR 2 | after NMR 3 | after NMR 4 | after NMR 5 |
| LCI₁ | LCI₁ | LCI₁ | LCI₁ | LCI₁ |
| Σ = 32 | Σ = 32 + 49 = 81 | Σ = 81 + 58 = 139 | Σ = 139 + 35 = 174 | Σ = 174 + 85 = 259 |
| valid = F | valid = F | valid = F | valid = F | valid = F |
| LCI₂ | LCI₂ | LCI₂ | LCI₂ | LCI₂ |
| Σ = 90 | Σ = 90 + 48 = 137 | Σ = 137 + 38 = 175 | Σ = 175 + 75 = 250 | Σ = 250 + 74 = 324 |
| valid = F | valid = F | valid = F | (R = 250/174 = 1.42) | (R = 1.25) |
| | | | valid = T | valid = T |
| LCI₃ | LCI₃ | LCI₃ | LCI₃ | LCI₃ |
| Σ = 58 | Σ = 58 + 18 = 76 | Σ = 76 + 12 = 88 | Σ = 88 + 46 = 134 | Σ = 134 + 52 = 186 |
| valid = F | valid = F | valid = F | valid = F | valid = F |
| LCI₄ | LCI₄ | LCI₄ | LCI₄ | LCI₄ |
| Σ = 11 | Σ = 11 | Σ = 11 | Σ = 11 + 19 = 30 | Σ = 30 |
| valid = F | valid = F | valid = F | valid = F | valid = F |
| | LCI₅ | LCI₅ | LCI₅ | LCI₅ |
| | Σ = 15 | Σ = 15 + 62 = 77 | Σ = 77 | Σ = 77 |
| | valid = F | valid = F | valid = F | valid = F |
| | LCI₆ | LCI₆ | LCI₆ | LCI₆ |
| | Σ = 23 | Σ = 23 | Σ = 23 | Σ = 23 + 18 = 41 |
| | valid = F | valid = F | valid = F | valid = F |

The LCI learning information is initialized with the values from the first network measurement report NMR 1. Because in the first report there are LCIᵢ with i=1, 2, 3, 4, the LCI learning information comprises a sum for these four local cell identities after server 200 has processed the first received cellular measurement report. So far, none of the local cell identities is considered to be the valid local cell identity of the serving cell (valid=F), because none of the sums exceeds the first threshold value of 200.

When the second network measurement report NMR 2 arrives, the LCI learning information is updated in two ways: On the one hand, new records are generated for new LCIs that have been provided for the first time in the second network measurement report. This concerns LCIᵢ with i=5, 6 in the presented example. On the other hand, the cumulative sums sumᵢ for LCIᵢ with i=1, 2, 3 are updated. Sum sum₄ for LCI₄ is not updated, because there is no Rx level data for LCI₄ in the second network measurement report. Similarly, as the third network measurement report NMR 3 arrives, the cumulative Rx level sums sumᵢ for LCIᵢ with i=1, 2, 3, 5 are updated, while sums sumᵢ with i=4, 6 are not changed, since no new data is received for these local cell identities.

Next, when the fourth network measurement report NMR 4 arrives, the cumulative Rx level sums sumᵢ for LCIᵢ with i=1, 2, 3, 4 are updated, while sums sumᵢ with i=5, 6 are not changed. However, now the LCI learning process notices that the Rx level sum sum₂ for LCI₂ is greater than the exemplary threshold value of “200”. This triggers the calculation of the ratio R between the sums for the local cell identities with the associated highest and the second highest sums, R=sum₂/sum₁.

In case the ratio exceeds the exemplary threshold value of “1.2”, the local cell identity with the highest cumulative Rx sum is determined to be the local cell identity of the serving cell. In the example considered here, the ratio is 1.42 after consideration of the fourth incoming report, and thus the local cell identity of the serving cell is assumed to be found. This is indicated in Table 3 with “valid=T” in the field for LCI₂.

Server 200 may now update the data that is stored for the serving cell with received measurement results that are associated to the local cell identity that has been determined to belong to the serving cell. (action 217) In order to limit the requirements on storage space, it is possible to use incoming network measurement reports for updating the sums sumᵢ, and then to discard the reports unless the monitored threshold values are exceeded. The measurement results in received network measurement reports could be used for updating the data for the serving cell only if the monitored threshold values are exceeded. With the example of Tables 2 and 3, for instance, network measurement reports NMR 1-3 could be used for updating the sums only and then be discarded, while network measurement reports NMR 4-5 could first be used for updating the sums, and then be used for updating for instance grid data that is associated with the serving cell with the Rx levels that are provided for LCI₂.

It is to be understood that any other kind of data that may be included in the received messages and associated with the determined local cell identity of the serving cell may be used for updating the database as well, if such data is supported by the database. It is further to be understood that the location indicated in the received messages could first be mapped to one of a plurality of supported locations, for instance to the closest grid point of a grid.

The process could now continue with actions 211 and 213-217 using Rx level values that are received in further cellular measurement reports. For instance, when a fifth network measurement report NMR 5 is received with Rx level values as shown in the last column of Table 2, the sums for LCIi with i=1, 2, 3, 6 may be updated as shown in the last column of Table 3. The highest sum sum₂ would still lie above the first threshold value threshold1=200, and as long as the ratio R still lies above the second threshold value threshold2=1.2, LCI₂ with the highest sum could be used again as the local cell identity of the serving cell.

However, in order to facilitate detection of a changed local cell identity of a serving cell and/or in order to accelerate correction of a wrongly determined local cell identity of a serving cell, the sums may be reset at predetermined instants of time. (action 212) For instance, the sums for a particular serving cell could be reset as soon as the local cell identity of the serving cell has been determined. Alternatively, the sums could be reset periodically when a timeout of some timer is detected. Further alternatively, the sums could be reset if the highest sum sumₘₐₓ exceeds a third threshold value threshold3. The latter alternative may have the effect that the range of the values of the sums that have to be supported can be limited. The two latter alternatives may have the effect that an error might be detected faster than with the first alternative.

It is to be understood that when the sums are reset in line with any of these alternatives, the determined LCI of the serving cell could be kept in the memory with an association to the GCI of the serving cell. This enables a continuous mapping of measurement results identified by LCIs in incoming network measurement reports to the correct GCI and thus the correct stored data. That is, for network measurement reports that arrive after a first determination of the local cell identity of the GCI, the data in the incoming reports may be used immediately for updating the stored data. It may then be determined in parallel, by computing new sums, whether the mapping of the LCI to a particular GCI is still valid or whether it has changed.

The same operation as described for a particular serving cell could be carried out by server 200 in parallel for all cells of cellular communication network 320 or even for all cells of various cellular communication networks in their respective function as a serving cell.

The updated data in the database in memory 206 may be used for supporting a positioning of mobile terminals. It has to be noted that also mobile terminals with GNSS capability may benefit from using cellular/non-cellular positioning technologies, in order to accelerate the time-to-first-fix, using the obtained location as reference location, or in order to reduce the power consumption. Furthermore, not all applications require a GNSS based position. Furthermore, positioning technologies that are based on terrestrial radio signals may be better suited to work indoors than positioning technologies that are based on satellite signals.

Summarized, certain embodiments of the invention may thus have the effect of enabling a learning of an identification of a particular cell, for instance a local cell identity of a serving cell, in a straightforward manner. This allows for instance using the signal strength measurement results from the network measurement report part of a cellular measurement in learning and positioning.

It is to be understood that the identification of a particular cell could also be determined in a mobile terminal based on measurement results on signals collected at the mobile terminal. In this case, the plurality of reports comprising the measurement results are provided and received internally in the mobile terminal. In an exemplary embodiment, the mobile terminal could then for instance send a message to a server, in which only measurement results for a particular cell are provided in the first place. Alternatively or in addition, a mobile terminal could report to a server the local cell identity that has been determined for a given global cell identity.

It is further to be understood that the identification of a particular cell of a cellular communication network could also be determined for any other purpose than positioning. For instance, it could be used for collecting information on a cellular communication network, like the coverage areas of cells or the quality of signals and its variation in a coverage area, etc.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:

(a) hardware-only circuit implementations (such as implementations in only analog and/or digital circuitry)

(b) combinations of circuits and software (and/or firmware), such as: (i) to a combination of processor(s) or (ii) to portions of processor(s)/software (including digital signal processor(s)), software, and memory(ies) that work together to cause an apparatus, such as a mobile phone, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or portion of a processor and its (or their) accompanying software and/or firmware. The term ‘circuitry’ also covers, for example, a baseband integrated circuit or applications processor integrated circuit for a mobile phone.

Any of the processors mentioned in this text could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Any of the memories mentioned in this text could be implemented as a single memory or as a combination of a plurality of distinct memories, and may comprise for example a read-only memory, a random access memory, a flash memory or a hard disc drive memory etc.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The functions illustrated by processor 101 or 201 in combination with memory 102 or 202, respectively, or the integrated circuit 205 can also be viewed as means for receiving a plurality of reports from at least one mobile terminal, which is connected to a particular cell of a cellular communication network, each report including an identification of a first type of a plurality of cells of the cellular communication network currently observed by the at least one mobile terminal and, associated with each identification of the first type, a result of at least one measurement on signals; means for computing for each identification of the first type a sum of results of the at least one measurement in the plurality of reports; and means for determining, based on the computed sums, one of the identifications of the first type to be an identification of the first type of the particular cell.

The program codes in memory 102 and 202, respectively, can also be viewed as comprising such means in the form of functional modules.

FIGS. 2 and 5 may also be understood to represent exemplary functional blocks of computer program codes for determining an identity of a cell.

It will be understood that all presented embodiments are only exemplary, and that any feature presented for a particular exemplary embodiment may be used with any aspect of the invention on its own or in combination with any feature presented for the same or another particular exemplary embodiment and/or in combination with any other feature not mentioned. It will further be understood that any feature presented for an exemplary embodiment in a particular category may also be used in a corresponding manner in an exemplary embodiment of any other category.

1-27. (canceled)

28. A method comprising at an apparatus:
receiving a plurality of reports from at least one mobile terminal, which is connected to a particular cell of a cellular communication network, each report including an identification of a first type of a plurality of cells of the cellular communication network currently observed by the at least one mobile terminal and, associated with each identification of the first type, a result of at least one measurement on signals;
computing for each identification of the first type a sum of results of the at least one measurement in the plurality of reports; and
determining, based on the computed sums, one of the identifications of the first type to be an identification of the first type of the particular cell.

29. The method according to claim 28, wherein each report further includes an identification of a second type for the particular cell.

30. The method according to claim 29, wherein the identification of the first type is a local cell identity and wherein the identification of the second type is a global cell identity.

31. The method according to claim 28, wherein the particular cell is a serving cell.

32. The method according to claim 28, wherein the at least one measurement on signals is a signal strength measurement.

33. The method according to claim 28, wherein determining one of the identifications of the first type to be an identification of the first type of the particular cell comprises determining the identification of the first type which is associated with the highest sum to be the identification of the first type of the particular cell.

34. The method according to claim 28, wherein before determining one of the identifications of the first type to be the identification of the first type of the particular cell based on the computed sums, the sums are computed cumulatively at least until at least one of:
one of the computed sums exceeds a first threshold value; and
a ratio between a highest computed sum and a second highest computed sum exceeds a second threshold value.

35. The method according to claim 28, wherein the sums are reset at least one of:
periodically; and
after one of the computed sums has reached a threshold value.

36. The method according claim 28, wherein at least one of the reports comprises in addition an indication of a position of the at least one mobile terminal.

37. The method according to claim 29, wherein results of measurements associated in the received reports to the identification of the first type, which is determined to be the identification of the first type of the particular cell, are stored in a positioning database with association to the identification of the second type for the particular cell.

38. An apparatus comprising at least one processor and at least one memory including computer program code, the at least one memory and the computer program code configured to, with the at least one processor, cause an apparatus at least to perform:
receive a plurality of reports from at least one mobile terminal, which is connected to a particular cell of a cellular communication network, each report including an identification of a first type of a plurality of cells of the cellular communication network currently observed by the at least one mobile terminal and, associated with each identification of the first type, a result of at least one measurement on signals;
compute for each identification of the first type a sum of results of the at least one measurement in the plurality of reports; and
determine, based on the computed sums, one of the identifications of the first type to be an identification of the first type of the particular cell.

39. The apparatus according to claim 38, wherein each report further includes an identification of a second type for the particular cell.

40. The apparatus according to claim 38, wherein the identification of the first type is a local cell identity and wherein the identification of the second type is a global cell identity.

41. The apparatus according to claim 38, wherein the particular cell is a serving cell.

42. The apparatus according to claim 38, wherein the at least one measurement on signals is a signal strength measurement.

43. The apparatus according to claim 38, wherein the computer program code is configured to, with the at least one processor, cause an apparatus to determine the identification of the first type which is associated with the highest sum to be the identification of the first type of the particular cell.

44. The apparatus according to claim 38, wherein the computer program code is configured to, with the at least one processor, cause an apparatus to compute the sums cumulatively at least until one of the computed sums exceeds a threshold value, before determining one of the identifications of the first type to be the identification of the first type of the particular cell based on the computed sums.

45. The apparatus according to claim 38, wherein the computer program code is configured to, with the at least one processor, cause an apparatus to compute the sums cumulatively at least until at least one of:
one of the computed sums exceeds a first threshold value; and
a ratio between a highest computed sum and a second highest computed sum exceeds a second threshold value,
before determining one of the identifications of the first type to be the identification of the first type of the particular cell based on the computed sums.

46. The apparatus according to claim 38, wherein the computer program code is configured to, with the at least one processor, cause an apparatus to reset the sums at least one of:
periodically; and
after one of the computed sums has reached a threshold value.

47. The apparatus according to claim 38, wherein the apparatus is one of:
a server;
a component for a server;
a mobile terminal; and
a component for a mobile terminal.
